(19) United States
(12) Patent Application Publication
(10) Pub. No.: US 2017/0038254 A1
(43) Pub. Date: Feb. 9, 2017

(54) OPTICAL RECEIVER MODULE

(71) Applicant: FUJITSU LIMITED, Kawasaki-shi (JP)

(72) Inventor: TAKATOSHI YAGISAWA, Kawasaki (JP)

(73) Assignee: FUJITSU LIMITED, Kawasaki-shi (JP)

(21) Appl. No.: 15/227,320

(22) Filed: Aug. 3, 2016

(30) Foreign Application Priority Data
Aug. 5, 2015 (JP) 2015-155135

(51) Int. Cl. G01J 1/46; H04B 10/60

(52) U.S. Cl. CPC G01J 1/46; H04B 10/60; G01J 2001/446

(57) ABSTRACT

An optical receiver module including: two amplifier arrays in each of which transimpedance amplifiers and first capacitors are arranged in an alternating manner, and an optical detector array, located between the two amplifier arrays, in which a plurality of optical detectors are aligned, wherein the plurality of optical detectors are coupled in an alternating manner to one of the transimpedance amplifiers of one of the two amplifier arrays and to one of the transimpedance amplifiers of the other of the two amplifier arrays, and for each specified optical detector of the plurality of optical detectors, the specified optical detector is coupled to one of the first capacitors of a second amplifier array of the two amplifier arrays, the second amplifier array being different from a first amplifier array that includes one of the transimpedance amplifiers to which the specified optical detector is coupled.

### CROSS-REFERENCE TO RELATED APPLICATION

This application is based upon and claims the benefit of priority of the prior Japanese Patent Application No. 2015-155135, filed on Aug. 5, 2015, the entire contents of which are incorporated herein by reference.

### FIELD

The embodiment discussed herein is related to an optical receiver module.

### BACKGROUND

A multichannel optical receiver module that has a photodiode array including a plurality of photodiodes linearly aligned and a Transimpedance Amplifier (TIA) circuit including a plurality of TIAs linearly aligned has been proposed.

A multichannel optical receiver module is a device that uses a photodiode array to photoelectrically convert optical signals emitted from a plurality of optical transmission lines. A photoelectrically converted optical signal is a current signal that is converted into a voltage signal by a TIA circuit. A multichannel optical receiver module is used for data transmission between devices such as computers and/or within a device such as a computer.

A photodiode array and a TIA circuit are mounted on the same substrate by using a flip-chip mounting. In this case, under-fills are filled between the photodiode array and the substrate and between the TIA circuit and the substrate. It is difficult to reduce the spacing between a photodiode array and a TIA circuit to less than a certain distance, while avoiding an overflow of this under-fill or the like.

However, a wider spacing between a photodiode array and a TIA circuit results in a narrower frequency bandwidth of a multichannel optical receiver module. Thus, for example, Japanese Laid-open Patent Publication No. 2012-142822 has proposed a technique of broadening the frequency bandwidth of a multichannel optical receiver module by coupling a separate capacitor to each photodiode of the photodiode array.

Japanese Laid-open Patent Publication No. 2001-345456 discloses another example of the related art.

### SUMMARY

According to an aspect of the invention, an optical receiver module includes two amplifier arrays in each of which transimpedance amplifiers and first capacitors are arranged in an alternating manner, and an optical detector array, located between the two amplifier arrays, in which a plurality of optical detectors are aligned, wherein the plurality of optical detectors are coupled in an alternating manner to one of the transimpedance amplifiers of one of the two amplifier arrays and to one of the transimpedance amplifiers of the other of the two amplifier arrays, and for each specified optical detector of the plurality of optical detectors, the specified optical detector is coupled to one of the first capacitors of a second amplifier array of the two amplifier arrays, the second amplifier array being different from a first amplifier array that includes one of the transimpedance amplifiers to which the specified optical detector is coupled.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a plan view of an optical receiver module of a first embodiment;

FIG. 2 is a sectional view taken along line II-II in FIG. 1;

FIG. 3 is a plan view of an amplifier array;

FIG. 4 is a plan view illustrating an example of an optical detector array;

FIG. 5 is a plan view of a parallel optical transmission line arranged in a back surface of a substrate;

FIG. 6 is a plan view of the back surface of the substrate;

FIG. 7 is a view illustrating a coupling from the optical detectors;

FIG. 8 is a view illustrating a multichannel optical receiver module on which separate capacitors are mounted;

FIG. 9 is a view illustrating a multichannel optical receiver module on which separate capacitors are mounted; and

FIG. 10 is a view illustrating a multichannel optical receiver module on which a separate capacitor is mounted.

### DESCRIPTION OF EMBODIMENT

An optical signal is input to a multichannel optical receiver module via optical transmission lines that are parallel to each other. Further, a photodiode array and a TIA circuit are coupled by electric wirings that are parallel to each other. The pitch of these electric wirings is substantially the same as the pitch of the optical transmission lines.

In order to increase the capacity of transmission lines, it appears to be effective to reduce the pitch of optical transmission lines to increase the density of the optical transmission lines. Reducing the pitch of optical transmission lines, however, leads to various difficulties arising due to a reduced pitch of electric wirings.

In a technique in which a separate capacitor is coupled to each photodiode, the pitch of electric wirings that couple a photodiode array to a TIA circuit is the same as the pitch of separate capacitors. Because the pitch of separate capacitors is limited by the size of the separate capacitors, it is difficult to reduce the pitch to a certain value or less. Therefore, a narrower pitch of electric wirings due to a narrower pitch of optical transmission lines makes coupling of separate capacitors and photodiodes difficult. Further, a narrower pitch of electric wirings due to a narrower pitch of optical transmission lines results in increased crosstalk between the electric wirings due to electromagnetic coupling.

Therefore, the present disclosure is to solve the above problems.

The embodiment of the present disclosure will be described below according to the drawings. However, the technical scope of the present disclosure is not limited to these embodiments but covers the claimed subject matter and equivalents thereof. Note that the same reference numerals are provided to corresponding elements even when provided in different drawings, and description thereof will be omitted.

(1) Configuration

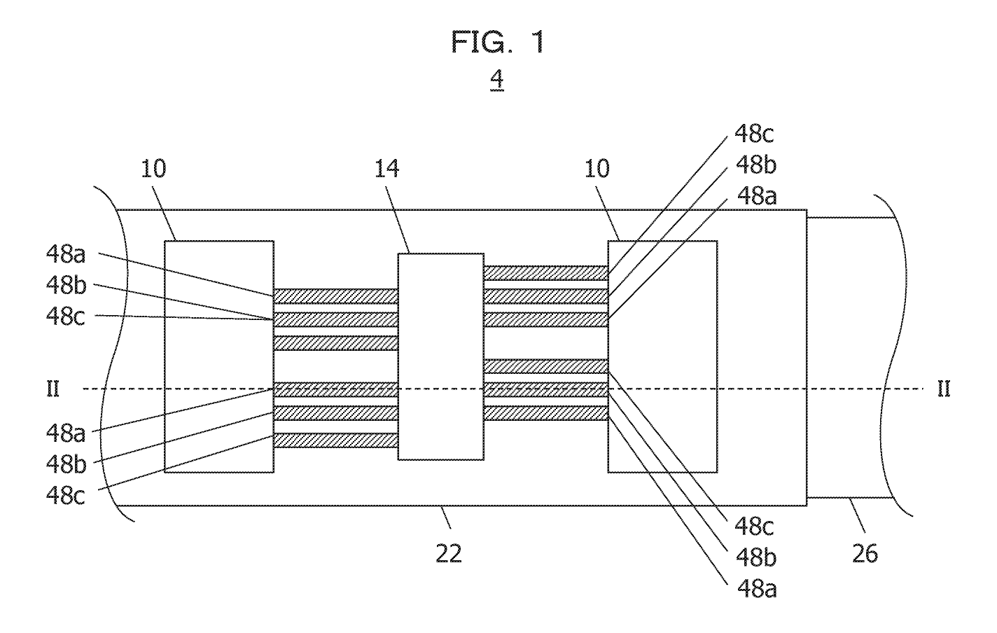

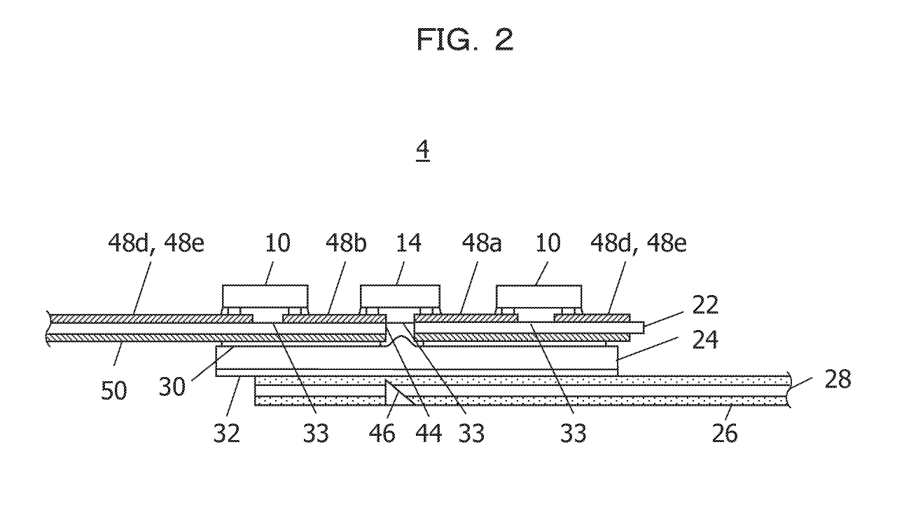

FIG. 1 is a plan view of an optical receiver module 4 of a first embodiment. FIG. 2 is a sectional view taken along line II-II in FIG. 1. FIG. 1 and FIG. 2 depict a member 26 including a plurality of optical transmission lines (for example, optical fibers and/or polymer waveguides) that are parallel to each other (hereafter, the member 26 is referred to as a parallel optical transmission line). The optical receiver module 4 is a multi-channel optical receiver module.

The optical receiver module 4 has an optical detector array 14 located between two amplifier arrays 10 as illustrated in FIG. 1 and FIG. 2. The optical receiver module 4 further has a substrate 22 on which the two amplifier arrays 10 and the optical detector array 14 are mounted. The substrate 22 is preferably a flexible printed board.

The substrate 22 is coupled to a printed board (not depicted) via an electric connector (not depicted), for example. Moreover, the parallel optical transmission line 26 (see FIG. 2) is arranged on the back surface of the substrate 22. The parallel optical transmission line 26 is a polymer waveguide having a plurality of optical fibers, for example.

The optical receiver module 4 preferably has a lens sheet 24 (see Japanese Laid-open Patent Publication No. 2012-68539) between the parallel optical transmission line 26 and the substrate 22. The lens sheet 24 is adhered to the substrate 22 by using an adhesive layer 32.

The two amplifier arrays 10 and the optical detector array 14 are preferably flip-chip-mounted to the substrate 22. In this case, under-fills 33 are filled between the optical detector array 14 and the substrate 22 and between the amplifier arrays 10 and the substrate 22. It is difficult to reduce the spacing between the optical detector array 14 and each of the amplifier arrays 10 to 1 mm or narrower, while avoiding an overflow of the under-fills 33 or the like. On the other hand, with the spacing between the optical detector array 14 and each of the amplifier arrays 10 being 2 mm or wider, the high-frequency characteristics of the optical receiver module 4 would be significantly deteriorated at 10 GHz or higher (for example, see Japanese Laid-open Patent Publication No. 2012-142822). Therefore, the spacing between the amplifier array 10 and the optical detector array 14 is preferably greater than or equal to 1 mm and less than or equal to 2 mm.

(1-1) Amplifier Array

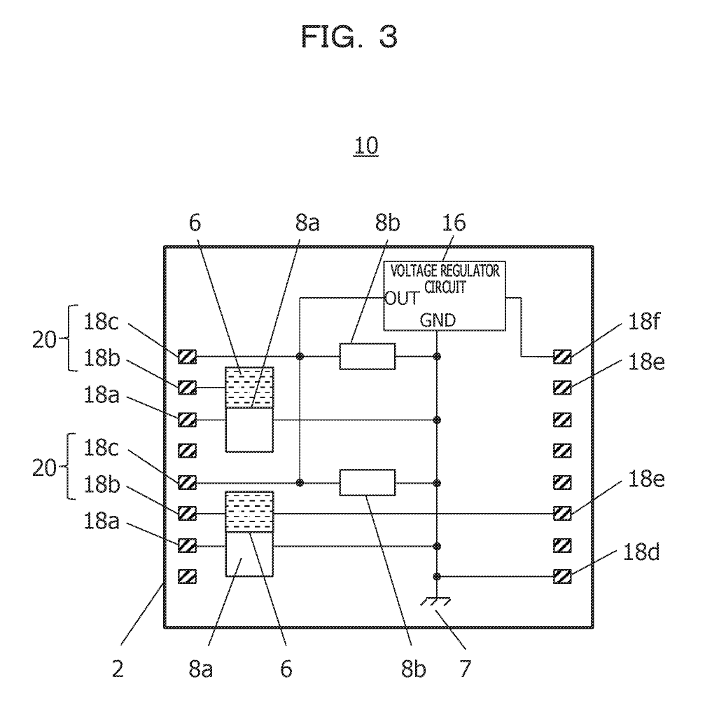

FIG. 3 is a plan view of the amplifier array 10. As illustrated in FIG. 3, the amplifier array 10 has a plurality of transimpedance amplifiers (hereafter, referred to as TIA) 6 and a plurality of first internal capacitors 8a.

The TIA 6 is a circuit that converts a current signal into a voltage signal. The TIAs 6 and the first internal capacitors 8a are arranged in an alternating manner in the direction of a side 2 as illustrated in FIG. 3.

The amplifier array 10 further has a voltage regulator circuit 16 and a plurality of second internal capacitors 8b. The amplifier array 10 further has a plurality of first terminals 18a.

Each of the first terminals 18a is coupled to a reference potential via one of the plurality of first internal capacitors 8a. Specifically, the first terminals 18a are coupled to a ground plane 7 of the amplifier array 10. A ground potential is coupled to the ground plane 7 from the substrate 22 via a fourth terminal 18d, for example.

The amplifier array 10 further has a plurality of channel inputs 20 each having a second terminal 18b and a third terminal 18c. Each second terminal 18b is coupled to one of the TIAs 6. Each second terminal 18b is coupled to each input of the TIA 6.

On the other hand, each of the third terminals 18c is coupled to the reference potential via one of the second internal capacitors 8b. The third terminals 18c are further coupled to an output of the voltage regulator circuit 16. The voltage regulator circuit 16 outputs a positive regulated voltage (a reverse bias voltage) via the third terminals 18c. The second internal capacitors 8b suppress a variation in a voltage output from the third terminals 18c.

The amplifier array 10 further has fifth terminals 18e and a sixth terminal 18f. Each of the fifth terminals 18e is coupled to each output of the TIA 6. The sixth terminal 18f supplies external power to the voltage regulator circuit 16. The first to sixth terminals are coupled to electric wirings on the substrate 22 by using solder bumps or the like, for example.

The amplifier array 10 is an integrated circuit, for example. That is, the TIAs 6 and the voltage regulator circuit 16 are circuits formed on a semiconductor substrate (for example, a silicon substrate). The first internal capacitors 8a and the second internal capacitors 8b are Metal-Insulator-Metal (MIM) capacitors formed on the semiconductor substrate.

(1-2) Optical Detector Array and Parallel Optical Transmission Line

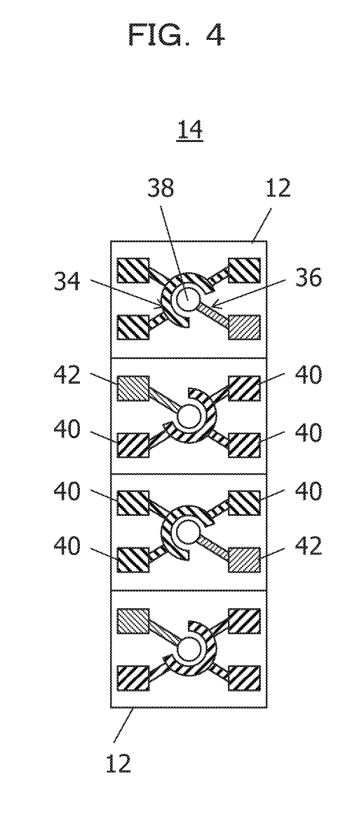

FIG. 4 is a plan view illustrating an example of the optical detector array 14. The optical detector array 14 has a plurality of optical detectors 12 linearly aligned. The optical detector array 14 is arranged such that a plurality of optical detectors 12 face the front surface of the substrate 22 (see FIG. 2).

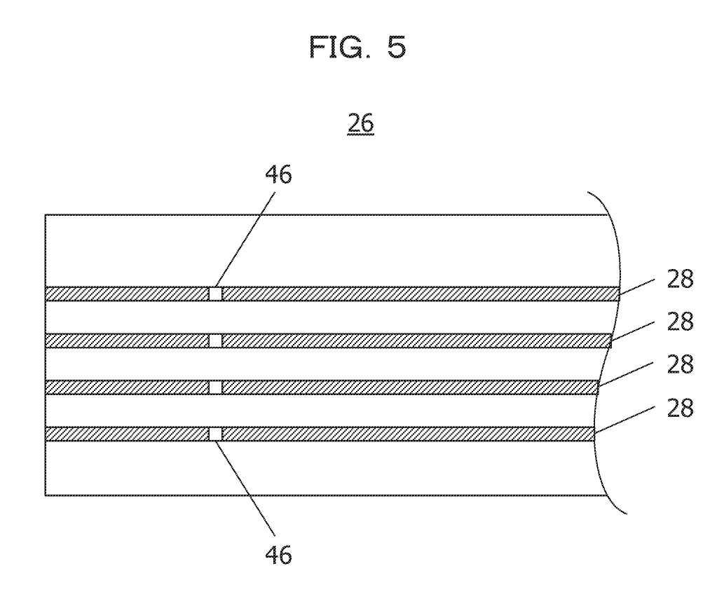

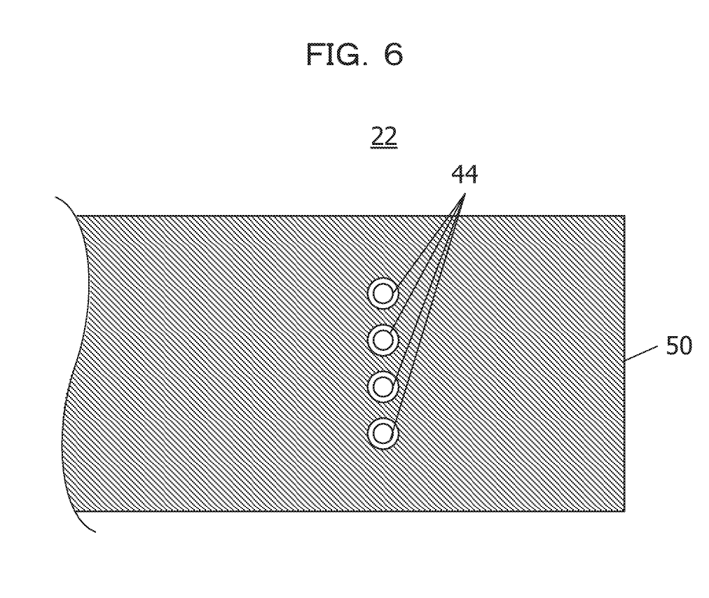

FIG. 5 is a plan view of the parallel optical transmission line 26 arranged on the back surface of the substrate 22. FIG. 6 is a plan view of the back surface of the substrate 22. As described above, the parallel optical transmission line 26 includes a plurality of optical transmission lines 28 that are parallel to each other. The plurality of optical transmission lines 28 are each an optical transmission line that is optically coupled to one of the plurality of optical detectors 12 via the substrate 22.

For example, a 45-degree mirror 46 is provided in each of the optical transmission lines 28. Upon reaching the 45-degree mirror 46, a light signal propagating in the optical transmission line 28 changes its traveling direction and enters one of the optical detectors 12 via a through hole 44 provided in the substrate 22 (see FIG. 2 and FIG. 6) and a lens sheet 24.

A convex portion, which functions as a micro lens, is provided on the lens sheet 24. A light signal whose traveling direction has been changed by the 45-degree mirror 46 is converged onto a light receiving surface of the optical detector 12 through the convex portion.

Optical Detector

Each of the optical detectors 12 of the optical detector array 14 (see FIG. 4) has a cathode 34 coupled to an n-type semiconductor layer and an anode 36 coupled to a p-type semiconductor layer. The cathode 34 preferably has a ring-shaped area surrounding a light receiving surface 38. The optical detector 12 is a pin photodiode formed in a GaAs layer, for example. The optical detector 12 may be any optical detector other than a pin photodiode.

Each of the cathodes 34 and each of the anodes 36 have pad-shaped coupling portions 40 and a pad-shaped coupling portion 42, respectively. The cathodes 34 and the anodes 36 are coupled to electric wirings on the substrate 22 by using solder bumps or the like provided on the coupling portions 40 and 42, respectively.

The coupling portions 40 of the cathodes 34 are provided on both one side and the other side of the optical detector array 14. On the other hand, the coupling portions 42 of the anodes 36 are provided in an alternating manner on one side and the other side of the optical detector array 14.

(1-3) Coupling from Optical Detector

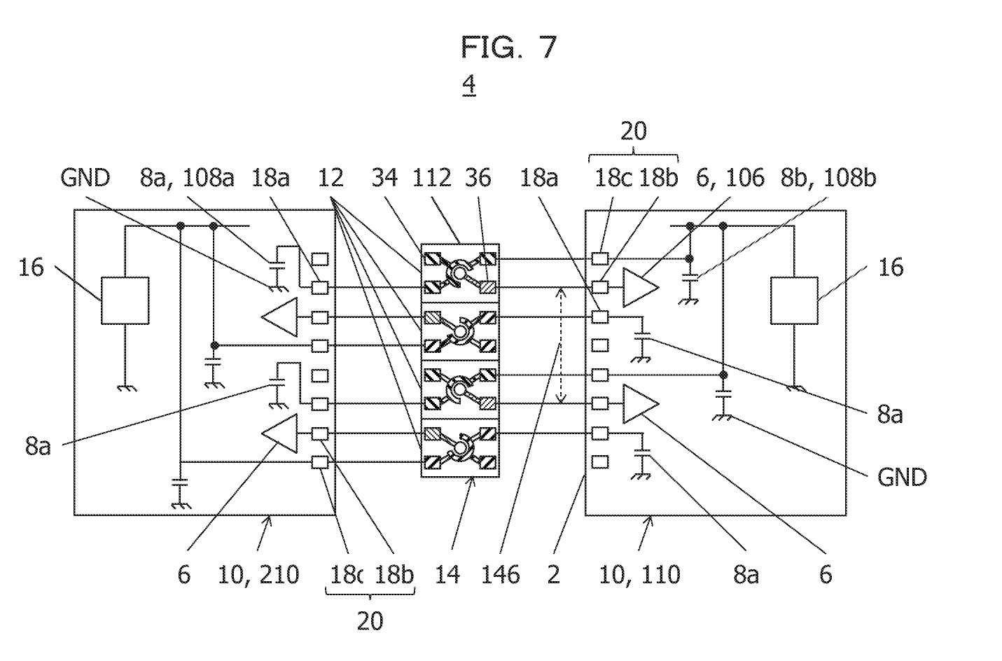

FIG. 7 is a view illustrating a coupling from the optical detectors 12.

(1-3-1) Coupling from Anode

The anodes 36 of the plurality of optical detectors 12 are coupled in an alternating manner to the TIAs 6 of one of the two amplifier arrays 10 and to the TIAs 6 of the other of the two amplifier arrays 10. Here, the anode 36 of each optical detector 12 (for example, the uppermost optical detector 112) is coupled to a TIA (for example, the top TIA 106) of one amplifier array (for example, the right amplifier array 110) via one of the second terminals 18b of the one amplifier array.

The pitch of the optical detectors 12 is greater than or equal to 100 μm and less than or equal to 300 μm, for example. When the pitch of the optical detectors 12 is 100 μm or greater (for example, 125 μm), a pitch 146 of electric wirings coupling the anodes 36 and the TIAs 6 will be 200 μm or greater (for example, 250 μm). Here, a wider pitch 146 of electric wirings allows for decreased crosstalk.

When the pitch of the optical detectors 12 is less than or equal to 300 μm, the density of the optical transmission lines 28 is the same as or greater than the density of optical transmission lines of an optical receiver module whose pitch of optical detectors is the narrowest among the conventional multi-channel light receiving modules.

(1-3-2) Coupling from Cathode

The cathode 34 of each optical detector 12 is coupled to one of the first internal capacitors 8a of the second amplifier array of the two amplifier arrays 10, and the second amplifier is different from the first amplifier array that includes the TIA 6 coupled to the optical detector 12 specified above. For example, the cathode 34 of the uppermost optical detector 112 of FIG. 7 is coupled to the uppermost first internal capacitor 108a of the left amplifier array 210 that is different from the right amplifier array 110 that includes the TIA 106 coupled to the anode 36 of the optical detector 112.

Furthermore, the cathode 34 of each optical detector 12 is coupled to one of the second internal capacitors 8b of the first amplifier array of the two amplifier arrays 10 that includes the TIA 6 coupled to the optical detector 12 specified above. For example, the cathode 34 of the uppermost optical detector 112 of FIG. 7 is coupled to the uppermost second internal capacitor 108b of the right amplifier array 110 including the TIA 106 coupled to the optical detector 112.

Furthermore, the cathode 34 of each optical detector 12 is coupled to the voltage regulator circuit 16 of the first amplifier array that includes the TIA 6 coupled to the above optical detector 12, and is subjected to a reverse bias voltage (for example, a positive regulated voltage) generated by the voltage regulator circuit 16.

Details of Coupling

More specifically, the cathode of each optical detector 12 (for example, the optical detector 112) is coupled to one of the first internal capacitors 8a (for example, the first internal capacitor 108a) via one of the first terminals 18a of the second amplifier array (for example, the amplifier array 210). Furthermore, the cathode of each optical detector 12 is coupled to one of the second internal capacitors 8b (for example, the second internal capacitor 108b) and the voltage regulator circuit 16 via one of the third terminals 18c of the first amplifier array (for example, the amplifier array 110).

As is apparent from FIG. 7, the two amplifier arrays 10 have the same circuit. Furthermore, when one of the amplifier arrays 10 is rotated about the center of the optical detector array 14, the first to third terminals of the one amplifier array 10 overlap the first to third terminals of the other amplifier array 10, respectively. Therefore, two amplifier arrays 10 can have the same structure including the location of terminals. Thus, development of only one type of integrated circuit is sufficient for the two amplifier arrays 10. This facilitates development of the two amplifier arrays 10.

(1-4) Electric Wiring

The substrate 22 (see FIG. 1) has, on its front surface, a plurality of second electric wirings 48b (see FIG. 1) each of which couples the anode 36 of each optical detector 12 (see FIG. 7) to one of the TIAs 6. Furthermore, the substrate 22 has, on its front surface, a plurality of first electric wirings 48a each of which couples the cathode 34 of each optical detector 12 to one of the first internal capacitors 8a. Furthermore, the substrate 22 has, on its front surface, a plurality of third electric wirings 48c each of which couples the cathode 34 of each optical detector 12 to one of the second internal capacitors 8b.

The two amplifier arrays 10 and the optical detector array 14 are flip-chip-mounted on the substrate 22 and coupled to the first to third electric wrings 48a, 48b, and 48c.

Furthermore, the substrate 22 has, on its front surface, electric wirings 48d (see FIG. 2) coupled to the output of the TIA 6 via the fifth terminals 18e (see FIG. 3) of the amplifier arrays 10. Furthermore, the substrate 22 has, on its front surface, electric wirings 48e (see FIG. 2) that supply power to the voltage regulator circuit 16 via the sixth terminals 18f (see FIG. 3) of the amplifier arrays 10, and the like. Note that, in FIG. 1, depiction of the fifth terminals 18e and the sixth terminals 18f is omitted.

Furthermore, the substrate 22 has a ground plane 50 (see FIG. 6) on the back surface thereof. The ground plane 50 and the first to third electric wirings 48a, 48b, and 48c form a micro-strip line. The ground plane 50 is coupled to the first and second internal capacitors 8a and 8b and the voltage regulator circuit 16 via the fourth terminals 18d (see FIG. 3) of the amplifier arrays 10 through vias provided in the substrate 22, for example. Another electric wiring which is coupled to the amplifier array 10 and the like other than the ground plane 50 may be formed on the back surface of the substrate 22.

As described with reference to FIG. 7, couplings from the optical detectors 12 are distributed in the amplifier arrays 10 in both sides of the optical detector array 14. Therefore, according to the embodiment, the pitch 146 between the electric wirings can be increased more than the pitch of the optical transmission lines 28.

(2) Operation

The plurality of optical detectors 12 (see FIG. 7) each receive an optical signal that propagates in the different optical transmission lines 28 (see FIG. 2). Each of the TIAs 6 converts, into a voltage signal (a signal based on a voltage), a current signal (a signal based on a current) generated by one of the plurality of optical detectors 12 in response to an optical signal. Therefore, the optical receiver module 4 can receive a plurality of optical signals at the same time.

In the optical receiver module 4 of FIG. 7, each first internal capacitor 8a is coupled to each optical detector 12. According to such a coupling arrangement, even when the electric wirings 48a, 48b, and 48c (see FIG. 1) for a flip-chip mounting have a certain length, a wide frequency bandwidth of the optical receiver module 4 can be maintained (for example, see Japanese Laid-open Patent Publication No. 2012-142822).

Moreover, according to the optical receiver module 4 of FIG. 7, since the different first internal capacitors 8a are coupled to respective optical detectors 12, cathode potentials of the optical detectors 12 can be stabilized on a channel basis (that is, on a TIA basis). Therefore, according to the optical receiver module 4 of FIG. 7, no crosstalk via a capacitor occurs (see “(3-3) Third Example of Mounting Separate Capacitor”).

(3) Optical Receiver Module with Separate Capacitor

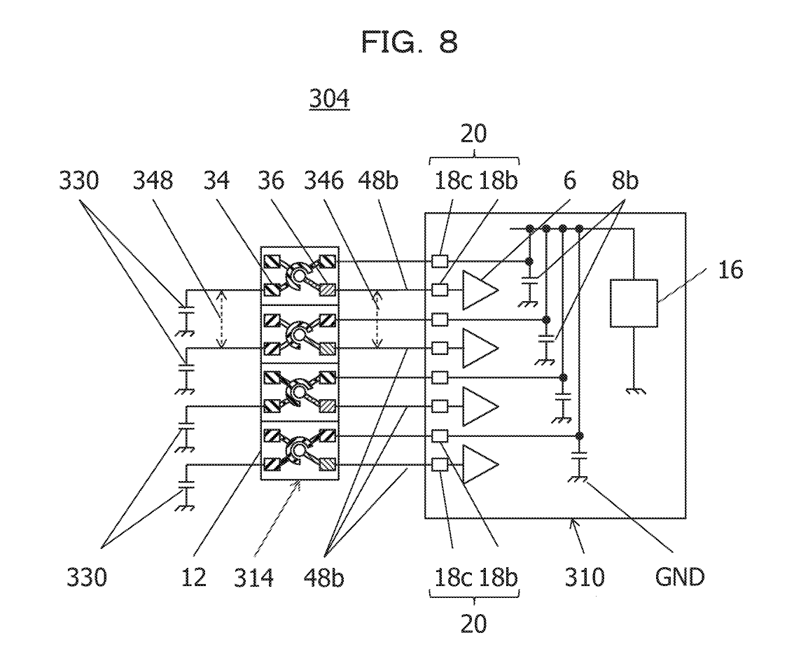

In the example of FIG. 7, the frequency bandwidth of the optical receiver module 4 is broadened by using the first internal capacitors 8a of the amplifier arrays 10. It is, however, possible to broaden the frequency bandwidth of the optical receiver module by using separate capacitors. FIG. 8 to FIG. 10 are views illustrating multichannel optical receiver modules on which one or more separate capacitors are mounted.

(3-1) First Example of Mounting Separate Capacitor

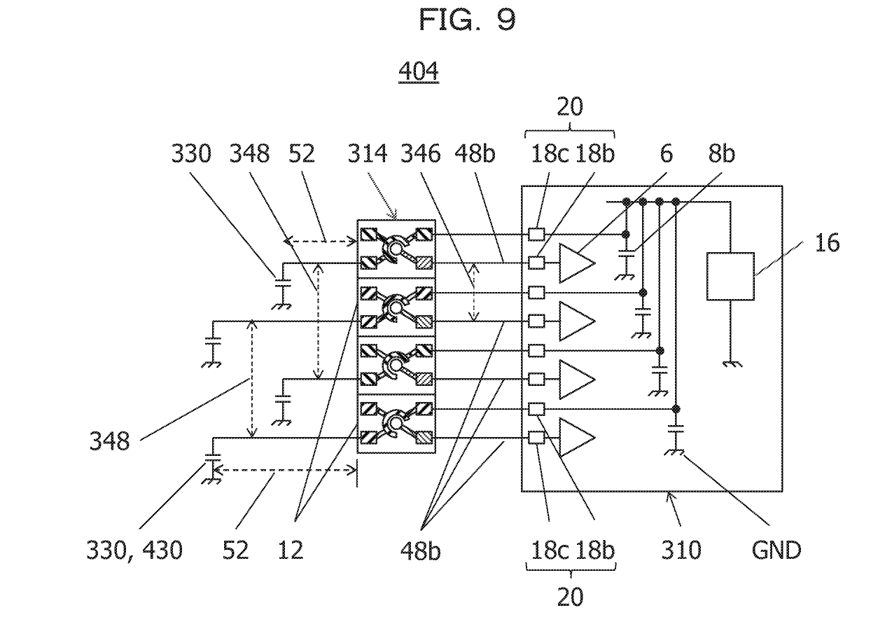

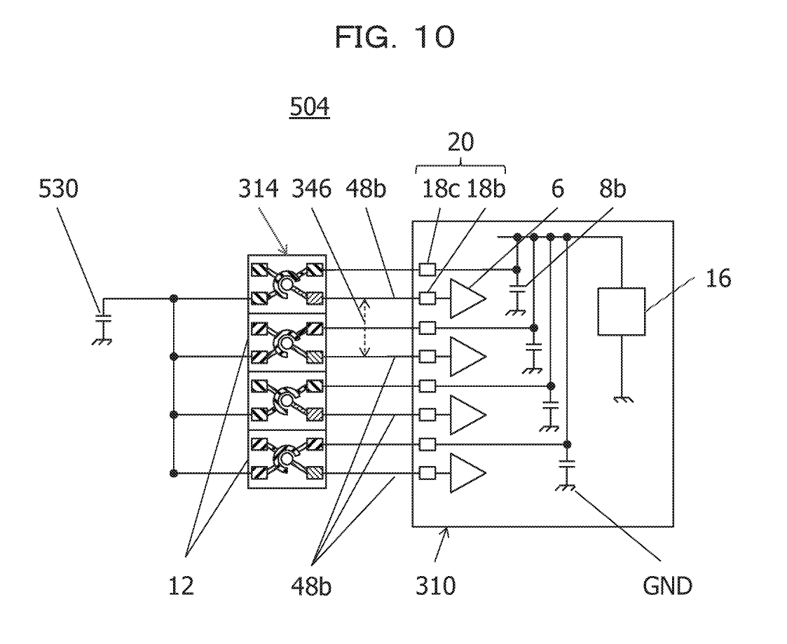

FIG. 8 is a view illustrating an example of an optical receiver module 304 in which each of a plurality of separate capacitors 330 is coupled to each of the optical detectors 12 of the optical detector array 314. FIG. 8 illustrates a positional relationship among the separate capacitors 330, the optical detectors 12, and the TIAs 6 (the same applies to FIG. 9 and FIG. 10 described later).

In the example of FIG. 8, the separate capacitors 330 are arranged on opposite sides of the amplifier array 310 interposing the optical detector array 314. The cathodes 34 of the optical detectors 12 are coupled to a reference potential GND via the separate capacitors 330.

The anodes 36 of the optical detectors 12 are coupled to the TIAs 6 via the second terminals 18b of the channel inputs 20. The cathodes 34 of the optical detectors 12 are coupled to the voltage regulator circuit 16 via the third terminals 18c. The voltage regulator circuit 16 generates a reverse bias voltage (for example, a positive regulated voltage) that is applied to the cathodes 34 of the optical detectors 12.

The optical detector array 314 and the amplifier array 310 are mounted on the same substrate by a flip-chip mounting. At this time, under-fills are filled between the optical detector array 314 and between the substrate (not depicted) and the amplifier array 310 and the substrate. It is difficult to reduce the spacing between the optical detector array 314 and the amplifier array 310 to a certain width (for example, 1 mm) or narrower, while avoiding an overflow of the under-fills of the like.

Now, let us assume that the separate capacitors 330 are removed from the optical receiver module 304 in FIG. 8. In this case, a wider spacing between the optical detector array 314 and the amplifier array 310 will result in a narrower frequency bandwidth of the optical receiver module. Specifically, with a spacing of 1 mm or wider between the optical detector array 314 and the amplifier array 310, an output of the optical receiver module will significantly decrease in a frequency bandwidth above 10 GHz (for example, see Japanese Laid-open Patent Publication No. 2012-142822).

To address this, each of the separate capacitors 330 is coupled to each of the optical detectors 12 of the optical detector array 314 as illustrated in FIG. 8. The coupling of these separate capacitors 330 allows for a wider frequency bandwidth of the optical receiver module (for example, see Japanese Laid-open Patent Publication No. 2012-142822).

An optical signal is input to the optical receiver module 304 via optical transmission lines that are parallel to each other (that is, parallel transmission lines). The optical detector array 314 and the amplifier array 310 are coupled by electric wirings that are parallel to each other. Therefore, in the optical receiver module 304 of FIG. 8, the electric wrings 48b that couple the optical detectors 12 to the TIAs 6 are arranged in the same pitch as optical transmission lines.

In order to increase a capacity of transmission lines, it appears to be effective to reduce the pitch of optical transmission lines to increase the density of the optical transmission lines. Reducing the pitch of optical transmission lines, however, leads to various difficulties arising due to the reduced pitch 346 of the electric wirings 346 that couple the optical detectors 12 to the TIAs 6.

In the optical receiver module 304 illustrated in FIG. 8, the pitch 348 of the separate capacitors 330 is the same as the pitch 346 of the electric wirings 48b.

Since the pitch 348 of the separate capacitors 330 is limited by the size of the separate capacitors 330, it is difficult to reduce the pitch to a certain value (specifically, 400 μm to 500 μm) or less. Therefore, in the optical receiver module 304 of FIG. 8, if the pitch 346 of the electric wirings 48b were reduced due to a reduced pitch between optical transmission lines, there would be a problem of a difficulty in coupling the separate capacitors 330 to the optical detectors 12.

Note that the pitch 348 of the separate capacitors 330 is a sum (for example, 400 μm) of a width of the separate capacitor 330 (for example, 200 μm) and a spacing for ensuring a performance of the separate capacitor 330 (for example, 200 μm).

Further, a reduced pitch of the electric wirings 48b due to a reduced pitch of optical transmission lines would cause crosstalk due to electromagnetic coupling between electric wirings. Therefore, in the optical receiver module 304 of FIG. 8, there is a problem of crosstalk being likely to occur due to electromagnetic coupling.

Note that ribbon fibers have been widely used as optical transmission lines for coupling between devices or between substrates (that is, optical transmission lines with optical intercouplings). Specifically, ribbon fibers in which the pitch of optical fibers is 250 μm have been widely used.

The latest ribbon fiber has a further reduced pitch, and a ribbon fiber having a pitch of 62.5 μm has been implemented. It is therefore difficult to form the optical receiver module 304 of FIG. 8 by using such a ribbon fiber (or an optical waveguide array).

Note that Japanese Laid-open Patent Publication No. 2012-142822 has proposed a multichannel optical receiver module in which each separate capacitor is coupled to each optical detector 12 by mounting the separate capacitors on both sides of a substrate. According to such an optical receiver module, it is possible to mount separate capacitors even when the pitch of optical transmission lines is reduced. But, a throughput and/or a yield rate will decrease, because manufacturing of such a multichannel optical receiving module includes a complicated process such as a perforating of a substrate.

(3-2) Second Example of Mounting Separate Capacitor

FIG. 9 is a view illustrating an example of an optical receiver module 404 in which each of separate capacitors 330 is coupled to each of the optical detectors 12 of the optical detector array 314.

In the optical receiver module 404 of FIG. 9, distances 52 between the separate capacitors 330 and the optical detectors 12 vary in a direction parallel to the optical detector array 314. Specifically, the distance 52 between the separate capacitors 330 and the optical detectors 12 varies by a cycle of twice the height of the optical detectors 12. This results in a wider pitch 348 of the separates capacitors 330.

Therefore, according to the optical receiver module 404 of FIG. 9, each of the separate capacitors 330 can be coupled to each of the optical detectors 12 even when the pitch 346 of the electric wirings 48b is reduced due to a reduction of the pitch of optical transmission lines.

When the spacing between the separate capacitors 330 and the optical detectors 12 is 2 mm or wider, however, outputs of the TIAs 6 significantly decreases in a frequency bandwidth above 10 GHz (for example, see Japanese Laid-open Patent Publication No. 2012-142822). It is therefore difficult to broaden the frequency bandwidth of a channel which is coupled to a separate capacitor 430 mounted at a position distant from the optical detector array 314.

Therefore, the optical receiver module 404 of FIG. 9 inherently has a problem of a difficulty in broadening the frequency bandwidth.

(3-3) Third Example of Mounting Separate Capacitor

FIG. 10 is a view illustrating an example of an optical receiver module 504 in which all the optical detectors 12 of the optical detector array 314 are coupled to a single separate capacitor 530.

It is possible to broaden a frequency bandwidth of an optical receiver module to some extent even with a single separate capacitor as illustrated in FIG. 10. Furthermore, in the optical receiver module 504 of FIG. 10, since the single separate capacitor 530 is used, it is easier to couple the separate capacitor 530 to the optical detectors 12 even when the pitch of optical transmission lines is reduced.

Upon the optical detector 12 receiving an optical signal, a signal current flows. A part of this signal current flows into the separate capacitor 530. In response, a voltage between both ends of the separate capacitor 530 varies. This voltage variation causes a current flow into other optical detectors 12 coupled to the separate capacitor 530. That is, crosstalk occurs.

Crosstalk due to the separate capacitor 530 is far larger than crosstalk due to electromagnetic coupling between the electric wirings 48b. Thus, there is a problem of increased crosstalk in the optical receiver module 504 of FIG. 10.

As described above, it is difficult to solve the problem caused by the reduced pitch of optical transmission lines with coupling one or more separate capacitors to the optical detectors 12. All the above problems are due to the fact that the pitch of optical transmission lines is equal to the pitch of electric wirings.

According to the embodiment, since elements to which the optical detectors 12 (see FIG. 7) are coupled are distributed in the amplifier arrays 10 in both sides of the optical detector array 14, the pitch of electric wirings can be increased more than the pitch of optical transmission lines. Therefore, the embodiment can overcome the problems caused by a reduced pitch of optical transmission lines.

The pitch 146 of electric wirings in the embodiment (see FIG. 7) is twice the pitch 346 of electric wirings of the optical receiver module of FIG. 8 to FIG. 10.

In the above examples, a reverse bias voltage applied to each optical detector 12 is generated by the voltage regulator circuit 16. However, a reverse bias voltage to each optical detector 12 may be generated by each TIA 6 coupled to each optical detector 12.

Further, in the above examples, the number of TIAs included in an amplifier array (that is, the number of channels) is two. However, the number of TIAs included in an amplifier array may be three or more.

Further, in the above examples, the first internal capacitors and the second internal capacitors are arranged in different lines. However, the first internal capacitors and the second internal capacitors may be linearly aligned.

Further, in the above examples, circuits mounted on the substrate 22 are amplifier arrays and an optical detector array only. However, circuits other than amplifier arrays and an optical detector array may be mounted on the substrate 22. For example, a central processing unit (CPU) that processes outputs of amplifier arrays may be mounted on the substrate 22.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An optical receiver module comprising:
two amplifier arrays in each of which transimpedance amplifiers and first capacitors are arranged in an alternating manner; and
an optical detector array, located between the two amplifier arrays, in which a plurality of optical detectors are aligned, wherein
the plurality of optical detectors are coupled in an alternating manner to one of the transimpedance amplifiers of one of the two amplifier arrays and to one of the transimpedance amplifiers of the other of the two amplifier arrays, and
for each specified optical detector of the plurality of optical detectors, the specified optical detector is coupled to one of the first capacitors of a second amplifier array of the two amplifier arrays, the second amplifier array being different from a first amplifier array that includes one of the transimpedance amplifiers to which the specified optical detector is coupled.

2. The optical receiver module according to claim 1, wherein
each of the plurality of optical detectors receives each optical signal propagating in each optical transmission line, and
each of the transimpedance amplifiers converts each current signal into each voltage signal, each current signal generated by each one of the plurality of optical detectors in response to each optical signal.

3. The optical receiver module according to claim 1, wherein
each of the two amplifier arrays further has a voltage regulator circuit, a plurality of second capacitors, a plurality of first terminals each of which is coupled to a reference potential via one of the first capacitors, a plurality of second terminals each of which is coupled to each of the transimpedance amplifiers, and a plurality of third terminals each of which is coupled to the reference potential via one of the plurality of second capacitors and coupled to the voltage regulator circuit,
a cathode of each of the optical detectors is coupled to one of the second capacitors via one of the third terminals of the first amplifier array and coupled to one of the first capacitors via one of the first terminals of the second amplifier array, and
an anode of each of the optical detectors is coupled to one of the transimpedance amplifiers via one of the second terminals of the first amplifier array.

4. The optical receiver module according to claim 1 further comprising:
a substrate including a plurality of first electric wirings each of which couples each of the optical detectors to one of the first capacitors, and a plurality of second electric wirings each of which couples each of the optical detectors to one of the transimpedance amplifiers, wherein
the two amplifier arrays and the optical detector array are flip-chip-mounted on the substrate and coupled to the plurality of first electric wirings and the plurality of second electric wirings.

5. The optical receiver module according to claim 4, wherein
the plurality of optical detectors face a front surface of the substrate, and
a plurality of optical transmission lines each of which is optically coupled to one of the plurality of optical detectors via the substrate are arranged on a back surface of the substrate.

6. The optical receiver module according to claim 4, wherein the substrate is a flexible printed board.
